(19) United States
(12) Patent Application Publication
(10) Pub. No.: US 2023/0043286 A1
(43) Pub. Date: Feb. 9, 2023

(54) METHODS AND SYSTEMS FOR DYNAMIC SPEND POLICY OPTIMIZATION

(71) Applicant: MASTERCARD INTERNATIONAL INCORPORATED, PURCHASE, NY (US)

(72) Inventors: Nitish KUMAR, Jamshedpur (IN); Gaurav DHAMA, Gurgaon (IN); Ankur ARORA, New Delhi (IN); Alok SINGH, Ghaziabad (IN)

(21) Appl. No.: 17/868,082

(22) Filed: Jul. 19, 2022

(30) Foreign Application Priority Data
Jul. 20, 2021 (IN) 202141032681

(51) Int. Cl. G06Q 20/40

(52) U.S. Cl. CPC G06Q 20/405; G06Q 20/4016

(57) ABSTRACT

Embodiments provide methods and systems for dynamic spend policy optimization. Method performed by server system includes receiving payment authorization request for payment transaction initiated by cardholder from acquirer. The payment authorization request includes transaction data. The method includes determining spend variables associated with cardholder based on transaction data and identifying at least one cardholder segment from a plurality of cardholder segments based on the spend variables and a clustering model. The at least one cardholder segment is associated with cardholder. The method includes accessing spend policy rules applicable to the payment transaction based on the transaction data and determining optimal spend threshold values corresponding to the spend policy rules applicable to the payment transaction based on the at least one identified cardholder segment and a reinforcement learning (RL) model. The method includes generating spend policy recommendation for cardholder based on the optimal spend threshold values.

### CROSS-REFERENCE TO RELATED APPLICATION

This application claims priority to Indian Patent Application No. 202141032681 filed Jul. 20, 2021, entitled “METHODS AND SYSTEMS FOR DYNAMIC SPEND POLICY OPTIMIZATION”, the entirety of which is incorporated herein by reference.

### TECHNICAL FIELD

The present disclosure relates to artificial intelligence processing systems and, more particularly to, electronic methods and complex processing systems for dynamically optimizing spend threshold values of spend policy rules.

### BACKGROUND

Spend policy thresholds are set by payment organizations such as issuers or payment gateway networks for controlling allowed spending by cardholders. Currently, spend policy thresholds are set of high-level spend rules that are designed to generate alerts to issuers when payment transactions go beyond defined spend policy threshold. For example, in one scenario, there are 28 spend rules defined based on a combination of various card product types (e.g., Premium, Non-Premium), geographical regions (e.g., cross-border, domestic), and transaction channel (e.g., card not present (CNP), point of sale (POS), automated teller machine (ATM), etc.). The spend rules are used to control anomalous spend which could potentially be a cash out attack or a fraud. These spend rules are made around single transaction ticket size and velocity of transaction such as 24 hours or 1 hour transaction velocity on transaction amount and/or transaction count. Further, there is a spend threshold for each spend rule which is set based on issuer's operation capacity to process spend policy alerts. The transaction velocities are ranked in an order and the highest few transactions of each spend rule are sent as alerts.

Additionally, currently used spend rules set the spend policy thresholds on the basis of country, region and market level, and do not take into account varied cardholder spend behaviors.

Thus, there exists a need for technical solutions for optimizing spend threshold values for spend policy rules in dynamic manner.

### SUMMARY

Various embodiments of the present disclosure provide systems, and methods for dynamically optimizing spend policy threshold values.

In one embodiment, a computer-implemented method is disclosed. The computer-implemented method performed by a server system includes receiving a payment authorization request for a payment transaction initiated by a cardholder from an acquirer. The payment authorization request includes transaction data. The method includes determining spend variables associated with the cardholder based, at least in part, on the transaction data and identifying at least one cardholder segment from a plurality of cardholder segments based, at least in part, on the spend variables and a clustering model. The at least one cardholder segment is associated with the cardholder. The method includes accessing spend policy rules applicable to the payment transaction based, at least in part, on the transaction data and determining optimal spend threshold values corresponding to the spend policy rules applicable to the payment transaction based, at least in part, on the at least one identified cardholder segment and a reinforcement learning (RL) model. The method includes generating spend policy recommendation for the cardholder based, at least in part, on the optimal spend threshold values.

### BRIEF DESCRIPTION OF THE FIGURES

For a more complete understanding of example embodiments of the present technology, reference is now made to the following descriptions taken in connection with the accompanying drawings in which:

FIG. 1 is an example representation of an environment, related to at least some example embodiments of the present disclosure;

FIG. 2 is a simplified block diagram of a server system, in accordance with an embodiment of the present disclosure;

FIG. 3 represents an information flow among various entities of the environment, in accordance with an embodiment of the present disclosure;

FIG. 4 is a block diagram representation of a reinforcement learning (RL) model, in accordance with an embodiment of the present disclosure;

FIG. 5 is a block diagram representation of a neural network architecture of the reinforcement learning model, in accordance with an embodiment of the present disclosure;

FIGS. 6A and 6B, collectively, are a flow chart for training the reinforcement learning model, in accordance with an embodiment of the present disclosure;

FIGS. 7A and 7B are graphical representations of a reward zone, in accordance with an embodiment of the present disclosure;

FIG. 8 is a flow diagram of a computer-implemented method for dynamically optimizing spend threshold values associated with spend policy rules using reinforcement learning model, in accordance with an embodiment of the present disclosure;

FIG. 9 is a simplified block diagram of an issuer server, in accordance with an example embodiment of the present disclosure; and

FIG. 10 is a simplified block diagram of a payment server, in accordance with an example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment network”, used herein, refers to a network or collection of systems used for the transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes that may include payment cards, letters of credit, checks, financial accounts, etc. Examples of networks or systems configured to perform as payment networks include those operated by such as, Mastercard®.

The terms “cardholder” and “customer” are used interchangeably throughout the description, and refer to a person who holds a payment instrument such as a credit or a debit card that can be used by a merchant to perform a card-not-present (CNP) payment transaction.

The term “spend policy rules”, used herein, refers to spend policies that are a set of high-level rules designed to generate alerts to issuer if the account level transactions go beyond defined spend limit threshold value. For example, a cardholder can be classified as an international traveler, a domestic traveler or someone who never travels. This information can then be used to alert unusual activity for a spend transaction using a card associated with someone who never travels is being is use in a different country.

### Overview

Various example embodiments of the present disclosure provide methods, systems, user devices and computer program products for optimizing spend threshold values of spend policy rules using reinforcement learning (RL) model.

In existing systems, the spend threshold values are not set using the observed fraud and decline rates of the transactions. The spend policy rules and the spend threshold values are much generalized and are not changed dynamically based on transaction behavior shift of the cardholders. However, the present disclosure aims to obtain spend threshold values for the spend policy rules which would optimize both fraud as well as decline rate. The present disclosure dynamically adapts spend threshold values for spend policy rules by taking two important aspects into consideration: (a) different cohort of cardholders can have distinct spend behavior and observed fraud rates, and (b) dynamic adaption in spend threshold values can be defined based on transaction behavior shift of cardholders.

In an example, the present disclosure describes a server system that provides spend policy recommendations to issuers along with payment authorization requests in real-time. The spend policy recommendation includes information of optimal spend threshold values for spend policy rules applicable to a payment transaction initiated by a cardholder. At the issuer, the optimal spend threshold values are compared with transaction velocity features of the payment transaction to determine whether to approve the payment transaction or not.

The server system includes at least a processor and a memory. In one non-limiting example, the server system is a payment server. The server system is configured to receive a payment authorization request for a payment transaction initiated by a cardholder from an acquirer. The payment authorization request in a standard format includes transaction data. The transaction data may include issuer identifier, acquirer identifier, merchant category code (MCC), merchant identifier, cross-border transaction flag, CNP indicator, payment card type (e.g., debit card, credit card, prepaid card, etc.), card product type (e.g., Premium, Non-Premium, Standard), etc.

The server system is configured to determine spend variables associated with the cardholder based on the transaction data and past spend transactions performed during a particular time (for example, last one month). The spend variables may include transaction velocity features based on the various payment transaction features such as, geography, transaction channel, customer risk profile (e.g., fraud patterns) of a cardholder based on spends at the different merchants, proportions of spend transactions with high fraud score transactions. The server system is configured to identify at least one cardholder segment from a plurality of cardholder segments based, at least in part, on the spend variables and a clustering model. The at least one cardholder segment is associated with the cardholder. In one example, the clustering model is deep embedded clustering model. The plurality of cardholder segments is generated by applying the deep embedded clustering model on spend variables of a plurality of cardholders.

In one embodiment, the server system is configured to access spend policy rules applicable to the payment transaction based, at least in part, on the transaction data. For example, if a payment transaction is performed at POS terminal using a premium card for domestic transaction, spend policy rules corresponding to transaction features (POS, premium card, domestic transactions) of the payment transaction are accessed.

Thereafter, the server system is configured to determine optimal spend threshold values corresponding to the spend policy rules applicable to the payment transaction based, at least in part, on the at least one identified cardholder segment and a reinforcement learning (RL) model. The reinforcement learning model is trained based, at least in part, on historical transaction data associated with each cardholder segment within a particular time interval (for example, last 1 year). In other words, the server system may further be configured to intensively learn the historical transaction data of each cardholder segment, to realize a more intelligent spend policy recommendation modeling.

The server system is configured to generate spend policy recommendation for the payment transaction based on the optimal spend threshold values. Then, the server system is configured to transmit the spend policy recommendation along with the payment authorization to an issuer associated with the cardholder for facilitating the payment transaction.

Various embodiments of the present disclosure offer multiple advantages and technical effects. For instance, the present disclosure provides a system for enhancing approval rates of payment processing requests by recommending dynamic spend threshold values for spend policy rules to payment transactions to issuers. The system also constantly learns from the real-time payment transactions and feedbacks loop on whether the payment transaction was approved or declined or was marked as fraud. Thus, the system provides a cost-effective solution to the issuer in terms of deciding how the payment transaction should be processed and what spend threshold values for spend policy rules need to be applied on a payment transaction.

The present disclosure adds an extra layer of intelligence for decision making that takes into account user spend behaviour and observed fraud behaviour. The spend policy optimization method and system provided by the present disclosure reduces fraud and cash-out attacks. Since the spend policy rules for a payment transaction is set by the issuer and/or based on spend variables of the payment transaction. Therefore, the techniques of the present disclosure apply reinforcement learning over the spend threshold values of spend policy rules to learn more optimal spend threshold values for different cohort of cardholders, to improve the approval rates of the payment transactions and to reduce fraud rates/alerts. In addition, the extraction and dimension reduction are applied to the multiple operational behaviors to further enhance the efficiency of reinforcement learning.

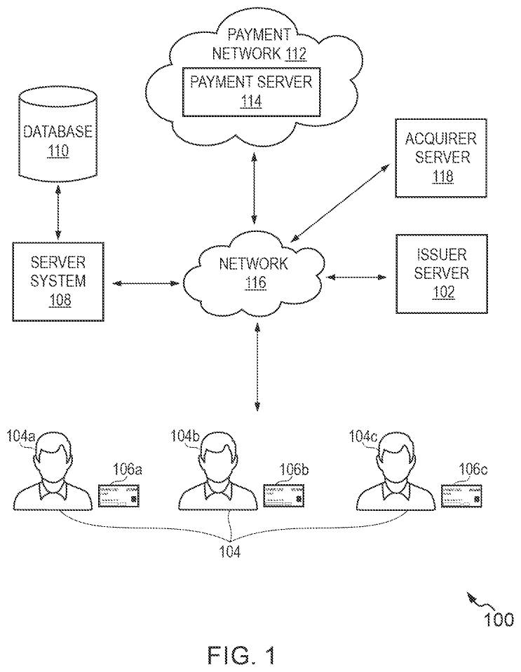

Various example embodiments of the present disclosure are described hereinafter with reference to FIGS. 1 to 10.

FIG. 1 illustrates an exemplary representation of an environment 100 related to at least some example embodiments of the present disclosure. Although the environment 100 is presented in one arrangement, other embodiments may include the parts of the environment 100 (or other parts) arranged otherwise depending on, for example, optimizing spend policy thresholds corresponding to spend policy rules, thereby reducing authorization decline rates and/or fraud rates for payment transactions. The environment 100 generally includes a plurality of entities, for example, an issuer server 102, a plurality of cardholders 104a, 104b, and 104c associated with a plurality of payment cards 106a, 106b, and 106c respectively, a payment network 112 including a payment server 114, an acquirer server 118, each coupled to, and in communication with (and/or with access to) a network 116. The network 116 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 116 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof. For example, the network 116 may include multiple different networks, such as a private network made accessible by the payment network 112 to the server system 108, issuer server 102, the payment server 114, and the acquirer server 118 separately, and a public network (e.g., the Internet etc.). The plurality of cardholders 104a-104c hereinafter is collectively represented as “cardholder 104”.

Examples of payment cards (such as, payment card 106a) may include, but are not limited to, a smartcard, a debit card, a credit card, etc. The cardholder such as the cardholder 104 may be any individual, representative of a corporate entity, non-profit organization, or any other person. The cardholder may have a payment account issued by corresponding issuing banks (associated with the issuer server 102) and may be provided the payment card with financial or other account information encoded onto the payment card such that the cardholder 104 may use the payment card to initiate and complete a transaction using a bank account at the issuing bank. The terms “issuer”, or “issuer server” will be used interchangeably herein.

In one embodiment, the acquirer server 118 is associated with a financial institution (e.g., a bank) that processes financial transactions. This can be an institution that facilitates the processing of payment transactions for physical stores, merchants, or an institution that owns platforms that make online purchases or purchases made via software applications possible (e.g., shopping cart platform providers and in-app payment processing providers). The terms “acquirer”, “acquirer bank”, “acquiring bank” or “acquirer server” will be used interchangeably herein.

In one embodiment, the issuer server 102 is a financial institution that manages accounts of multiple cardholders. Account details of the accounts established with the issuer bank are stored in cardholder profiles of the cardholders in a memory of the issuer server 102 or on a cloud server associated with the issuer server 102. The terms “issuer server”, “issuer”, or “issuing bank” will be used interchangeably herein.

In one example, to initiate a payment transaction, a cardholder 104 may visit a retail store operated by a merchant, select goods that he/she wishes to purchase, and presents his/her payment card to a merchant's Point Of Sale (POS) terminal. The POS terminal reads the cardholder's payment card account number from the payment card, and then sends a payment authorization request to the acquirer server 118 associated with a financial institution with which the merchant has a relationship. The payment authorization request typically includes payment card account number, the amount of the transaction and other information, such as merchant identification and location. The payment authorization request message is routed via the payment network 112 to the issuer 102 that issued the cardholder's payment card. In addition to POS transactions, the acquirer 118 may process payment transactions associated with Automated Teller Machine (“ATM”) withdrawals and Card Not Present (CNP) transactions in a similar manner.

While approving the payment authorization request, the issuer server 102 may check cardholder's identity, fraud risk, spend threshold limits of each spend policy rule applicable to the payment transaction. Based on these checks, the issuer 102 may approve/decline the payment transaction and generate a payment authorization response message. The format of the payment authorization request and authorization response messages are based on the ISO standard 8583, which is a standard for systems that exchange electronic transaction information associated with payments made by users using the payment card, or the payment account. This standard specifies the data format of the messages, and has a strictly defined set of data elements.

In one example, the issuer 102 may store various spend policy rules defined based on various combination of transaction indicators (such as, card product types, geography-cross border, domestic, transaction channel (e.g., CNP, POS, QC (Quasi-Cash), ATM). The spend policy rules are applied over spend variables such as, transaction velocities on transaction amount, transaction ticket size, transaction location etc. In other words, the issuer 102 compares the transaction velocities of the cardholder with spend threshold values of applicable spend policy rules and approves or declines real-time payment transaction of the cardholder 104. The following table 1 depicts some spend policy rules for premium cards:

TABLE 1

| Spend policy | Alert Reason | Threshold value/ |
|---|---|---|
| rule Definitions | code | count |
| Transaction Limit- | Daily cross-border | 7000 |
| Premium Card-24 hrs | transaction limit | |
| Transaction Limit- | ATM-Cross Border- | 300 |
| ATM-Cross Border- | Single Transaction | |
| Premium-Single | Limit | |
| Count-ATM-Cross | ATM-Cross Border- | 10 |
| Border-Premium-24 hrs | Single Transaction | |
| | Count-24 hrs | |
| Transaction Limit- | CNP-Cross Border | 500 |
| CNP-Cross Border- | Single Transaction | |
| Premium-Single | Limit | |

The cardholder 104, the acquirer 118, the issuer 102, and the payment server 114 all have an interest in reducing fraudulent transactions. Moreover, it is desirable to reduce fraudulent transactions without declining transactions that are, in fact, not fraudulent. However sometimes, a large number of payment transactions is declined by the issuer 102 when the payment transactions go beyond pre-defined or static spend threshold values that may lead to impact negatively on revenue of the issuer 102.

The environment 100 includes a server system 108 configured to perform one or more of the operations described herein. In one example, the server system 108 coupled with a database 110 is embodied in the payment network 112. The database 110 may store spend policy rules associated with one or more issuers. In general, the server system 108 is configured to dynamically adapt spend threshold values for spend policy rules by taking two important aspects into consideration: (a) different cohort of cardholders can have distinct spend behavior and observed fraud rates, and (b) dynamic adaption in spend threshold values can be defined based on transaction behavior shift of cardholders. The server system 108 is configured to determine spend threshold values on each spend policy rule which would optimize both fraud rate as well as decline rate of payment transactions. In other words, the server system 108 is configured to set spend threshold limits in such a way which leads to least fraud and decline rates, simultaneously.

The server system 108 is a separate part of the environment 100, and may operate apart from (but still in communication with, for example, via the network 116) the issuer server 102, the payment server 114, the acquirer server 118, and any third party external servers (to access data to perform the various operations described herein). However, in other embodiments, the server system 108 may actually be incorporated, in whole or in part, into one or more parts of the environment 100, for example, the payment server 114, the issuer server 102, or the acquirer server 118. In addition, the server system 108 should be understood to be embodied in at least one computing device in communication with the network 116, which may be specifically configured, via executable instructions, to perform steps as described herein, and/or embodied in at least one non-transitory computer-readable media.

In one embodiment, the payment network 112 may be used by the payment cards issuing authorities as a payment interchange network. The payment network 112 may include a plurality of payment servers such as, the payment server 114. Examples of payment interchange network include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

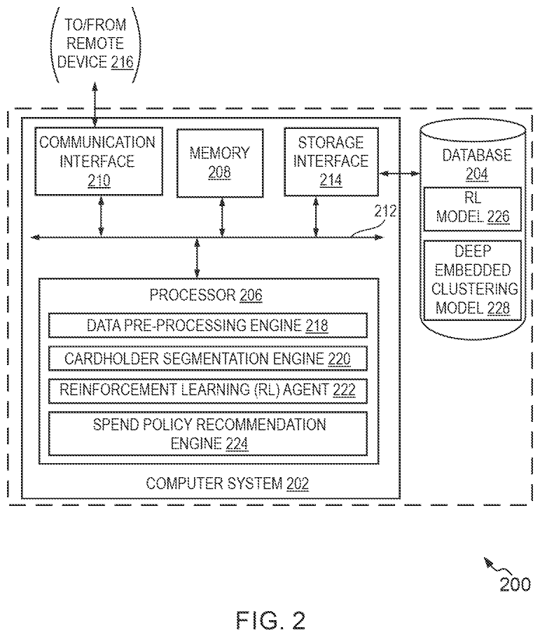

FIG. 2 is a simplified block diagram of a server system 200, in accordance with an embodiment of the present disclosure. The server system 200 is similar to the server system 108. In some embodiments, the server system 200 is embodied as a cloud-based and/or SaaS-based (software as a service) architecture. In one embodiment, the server system 200 is a part of the payment network 112 or is integrated within the payment server 114. In another embodiment, the server system 200 is embodied within the issuer server 102. In yet another embodiment, the server system 200 is embodied within the acquirer server 118. The server system 200 creates a two-staged framework to find optimal spend threshold values for a group of cardholders based on their spend behavior and observed fraud. In other words, the server system 200 facilitates a decision making process that takes into account users' spend behavior and observed fraud behavior.

The server system 200 includes a computer system 202 and a database 204. The computer system 202 includes at least one processor 206 for executing instructions, a memory 208, and a communication interface 210, that communicate with each other via a bus 212.

In some embodiments, the database 204 is integrated within computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 is configured to store RL model 226, and deep embedded clustering model 228.

Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210 such that the processor 206 is capable of communicating with a remote device 216 such as, the issuer server 102, or the payment server 114, or communicated with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a data pre-processing engine 218, a cardholder segmentation engine 220, a reinforcement learning (RL) agent 222, and a spend policy recommendation engine 224. It should be noted that the components, described herein, can be configured in a variety of ways, including electronic circuitries, digital arithmetic and logic blocks, and memory systems in combination with software, firmware, and embedded technologies.

The data pre-processing engine 218 includes suitable logic and/or interfaces for accessing historical payment transaction data of each cardholder associated with the issuer 102 or a particular region (e.g., country). The historical payment transaction data includes, but is not limited to, payment authorization data of past spend transactions made by the cardholder 104 within a particular time duration (for example, last one year). The payment authorization data of a spend transaction may include, but not limited to, authorization response (e.g., approve or decline), issuer identifier, acquirer identifier, merchant category code (MCC), merchant identifier, cross-border transaction flag, payment card type (e.g., debit card, credit card, prepaid card, etc.), spend transaction amount, transaction date and time, etc.

Along with the payment authorization data, the historical payment transaction data may also include fraud risk scores of the past payment transactions. In one example, payment transactions performed at riskier merchants have high fraud risk scores.

The data pre-processing engine 218 is configured to aggregate spend transaction amounts of the past spend transactions on a timely basis based on various payment transaction features such as, geography, card product types, transaction channel and merchant category code (MCC). The aggregation is performed to generate transaction velocity features (for example, average of 1 hour and 24-hour transaction amount and transaction count) of the cardholder 104 on the various payment transaction features such as, geography, transaction channel and merchant category code (MCC). In one embodiment, the frequency of aggregation can be defined as hourly, weekly, daily, monthly, quarterly, based on spend frequency associated with the cardholder 104 at the various merchants. In other way, the data pre-processing engine 218 is configured to determine mean transaction amount at different geography and transaction Channel.

More illustratively, the data pre-processing engine 218 is configured to derive customer risk profiles of cardholders based on spend at different merchants. The cardholders that transact on riskier MCCs tend to have higher fraud than transacting on non-risky MCCs. In other words, the data pre-processing engine 218 is configured to perform normalized aggregation of customer risk profiles of the cardholders. The data pre-processing engine 218 is configured to further determine total percentage of transaction amount and transaction count at risky versus non-risky merchants by the cardholder 104.

The data pre-processing engine 218 is configured to determine proportions of spend transactions performed by the cardholder 104 in different geographical regions (such as, cross border, domestic) with various transaction channels (such as CNP, POS, QC and ATM). In one embodiment, the data pre-processing engine 218 may utilize any pre-processing techniques such as feature extraction processes for generating spend variables.

Consequently, the spend variables may include transaction velocity features based on the various payment transaction features such as, geography, transaction channel, customer risk profile (e.g., fraud patterns) of a cardholder based on spends at the different merchants, proportions of spend transactions with high fraud score transactions (i.e., total percentage of fraud and non-fraud transactions by the cardholder), etc.

The cardholder segmentation engine 220 includes suitable logic and/or interfaces for segmenting a plurality of cardholders into homogenous cardholder segments based on the spend variables of the plurality of cardholders. The cardholder segmentation engine 220 implements a clustering model. In one example, the clustering model is deep embedded clustering model 228 stored in the database 204. The main objective of the clustering model is to define different homogeneous cardholder segments or cohorts based on spend behavior and fraud patterns of the plurality of cardholders associated with the issuer 102 or a particular geographical region.

In general, the deep embedded clustering model 228 may include a deep neural network (DNN) or an auto encoder. The deep embedded clustering model 228 facilitates the cardholder segmentation engine 220 to cluster data by simultaneously learning a set of k cluster centers in a feature space and the parameters of the DNN that maps data points into the feature space. The deep embedded clustering model 228 includes two stages such as: (1) parameter initialization and (2) parameter optimization. The parameter initialization may be performed using a deep auto encoder such as a stacked auto encoder. The stacked auto encoder may be configured to produce semantically meaningful and well separated segments. The cardholder segments learned by the stacked auto encoder in first phase facilitate the learning of clustering representations. To initialize the cluster centers, the data learned at the first phase are passed through the initialized deep neural network to get embedded data points and then perform standard k-means clustering to finally obtain the cardholder segments.

In one example, the deep embedded clustering model 228 is performed for premium and non-premium cardholders separately to determine premium cardholder segments and non-premium cardholder segments, respectively. The spend variables used for the deep embedded clustering model 228 may include the following:
1) 90th and 50th percentile—Spend velocities of 1 hour, 24 hour and single transaction ticket size on cross-border/domestic and on different transaction channels such as CNP, POS, Quasi-Cash (QC) and ATM,
2) Spend behavior of cardholder on different MCCs,
3) Proportion of transactions in different geographies and transaction channels,
4) Proportion of transactions with high fraud score transactions, etc.

In one example implementation, the cardholder segmentation engine 220 determines six cardholder segments for the premium cardholder category based on the deep embedded clustering model 228. A ranking of spend transactions in terms of fraud rates might be classified into high/medium/low categories across qualifying cardholder segments for all issuer spend amounts in the same cardholder segment, as illustrated by Table 2:

TABLE 2

| Cardholder Segments | Details |
|---|---|
| Very High Cross-Border | a) 70% of all XB CNP fraud, |
| (XB) CNP Fraud | b) 55.59 Fraud BPS |
| Risk Segment | |
| Low XB CNP Fraud | a) 6.2% of all XB CNP fraud |
| Risk Segment | b) 86% domestic transactions |
| | c) Low overall XB fraud BPS 9.57 |
| High XB CNP & POS | a) 20% of XB CNP and 36% of XB |
| Velocities Segment | POS Fraud |
| High Domestic CNP | a) Highest domestic CNP fraud BPS |
| Fraud Segment | of 5.07 |
| High XB, QC, POS and | b) Very high velocity of QC, POS, |
| ATM Spend and | and ATM on cross-border |
| fraud Segment | |
| Inactive Segment | a) Annually transaction count less |
| | than 5 |
| | b) overall annual spend less than $200 |

In one embodiment, in response to receiving a real-time payment authorization request associated with a cardholder 104a, the data pre-processing engine 218 is configured to extract transaction data associated with the payment authorization request. Based on the transaction data and past spend transactions performed during a particular time (for example, last one month), the spend variables for the cardholder 104a are determined. The transaction data may include issuer identifier, acquirer identifier, merchant category code (MCC), merchant identifier, cross-border transaction flag, card-not-present (CNP) indicator, payment card type (e.g., debit card, credit card, prepaid card, etc.), card product type, etc.

Thereafter, the cardholder segmentation engine 220 is configured to identify at least one cardholder segment from a plurality of cardholder segments based, at least in part, on the spend variables and the clustering model.

The RL agent 222 includes suitable logic and/or interfaces for predicting or determining optimal spend threshold values corresponding to spend policy rules applicable to the payment transaction (associated with the payment authorization request). The RL agent 222 is responsible for defining spend policy thresholds for each spend policy rule and for each cardholder segment. The RL agent 222 implements a reinforcement learning (RL) model that is trained based on historical transaction data of cardholders associated with each cardholder segment within a particular time interval.

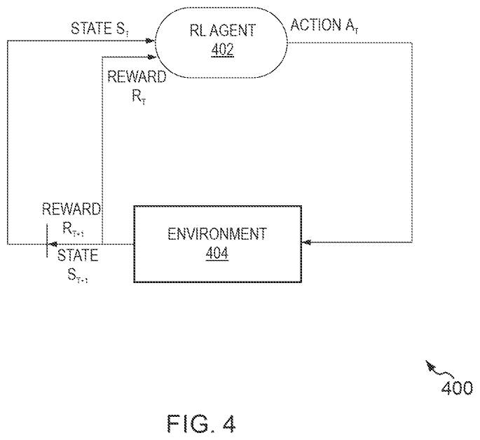

In order to express the use of reinforcement learning for setting dynamic spend thresholds for spend policy rules, the present disclosure explains theoretical models of the reinforcement learning model, and the Markov Decision Process (MDP) with reference to FIG. 4 in more detail. It would be apparent to those skilled in the art that several of deep reinforcement learning models may be applied to accomplish the spirit of the present disclosure.

During the training process, the RL agent 222 is configured to define state space and action space of the RL model 226. The state space represents fraud rate and decline rates observed for spend threshold values set for each spend policy rule. The action space represents the setting of spend threshold values for the spend policy rules applicable for the payment transaction. The training objective is to find optimal spend threshold values of the spend policy rules for each cardholder segment. The RL agent 222 is configured to initialize a random spend policy threshold value for each spend policy rule and calculate the fraud rate and decline rate associated with each spend policy rule based on the random spend policy threshold value. In one embodiment, the RL agent 222 is configured to run a plurality of episodes to train the RL model 226 to determine optimized spend policy threshold values for each spend policy rule. In one example, various batches of payment transactional features are aggregated in monthly transactional data. Spend threshold values are initialized randomly for each spend rule for one batch of transaction data, say at the beginning of the month. Further, the fraud and decline rates are calculated at the end of the month, which becomes the new state of the environment of the RL agent 222. Based on the fraud and decline rate of the new state, the RL agent 222 is rewarded using the reward function that is defined using the fraud and decline rates. Based on the reward, the RL agent 222 is configured to take an action by setting a different spend policy threshold value for each spend rule.

Similarly, at the end of each month, the reward is calculated and the RL agent 222 moves to a new state. This sequence may be performed for a batch of twelve months of data. Each sequence may be called an episode. Several episodes that mimic a spend policy threshold value had it been implemented optimizing both fraud and decline rate are created.

More illustratively, after performing an action, the RL agent 222 is configured to calculate a reward value based on selected action. In particular, the RL agent 222 is configured to calculate immediate reward values associated with each state-action pair associated with each episode based on the reward function. The immediate reward value may reflect an impact on the overall fraud and decline rates after setting a particular spend threshold value to each spend policy rule. The reward value may be based on multiple different values and may be determined using an algorithm that weigh different values differently. For example, the reward value may be calculated as a function of both fraud and decline rates.

The RL agent 222 is configured to provide a positive reward to the RL model 226 in response to observing each optimal state-action pair in an episode. In one embodiment, the processor 206 is configured to store the reward values associated with all the state-action pairs of each of the episodes in a database such as the database 204. Further, a cumulative reward value associated with each episode is calculated by the RL agent 222 to determine if spend threshold values of spend policy rules at the end of each episode is optimal or sub-optimal.

Initially, while the setting of spend threshold values for spend policy rules at end of initial episodes are sub-optimal, a combination of state, action and reward values obtained at each step during the initial episodes are used for training the RL model. The term “sub-optimal” herein refers to policies that may not be the ideal or optimal policy for proceeding with the spend policy rules. In an analogy for game theory, the sub-optimal policies may represent one or more possible moves that have been identified as “good” or likely to lead to a winning outcome. Because of the uncertainty in the system and the vast number of possibilities, the RL model may be unable to identify a single “optimal” policy. However, based on prior simulations (or records of spend policy rules), the RL model is configured to identify the possible next steps for the current state that will lead to an efficient or beneficial outcome. In next episodes, the RL agent 222 is configured to randomly sample (equal to batch size) the [state, action, reward] combination pairs stored in the memory and perform adjustment of neural network parameters of the RL model using the sampled combination pairs.

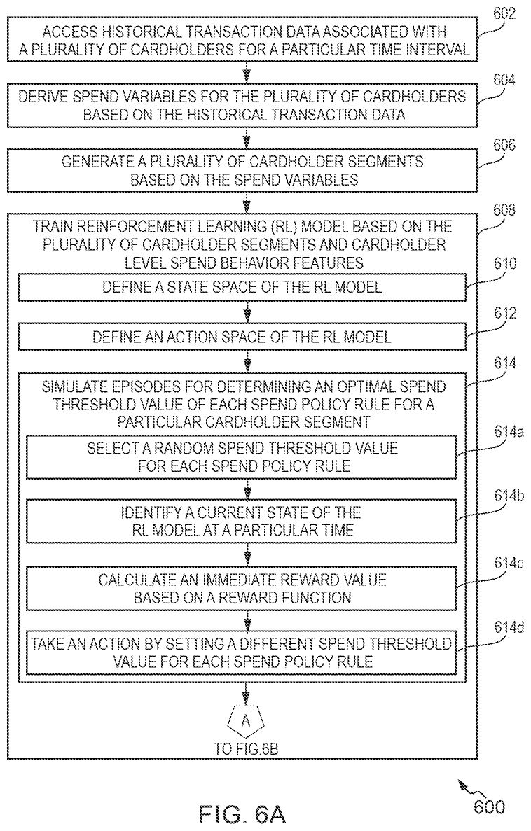

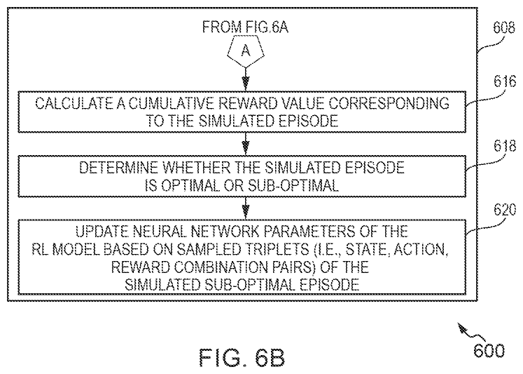

The running of a new episode is stopped when a convergence point is met. The convergence point refers to a cumulative reward value for the state-action pairs for an episode has been maximized to a predefined threshold value. The convergence point predicts the most optimized fraud and decline rates. The training process of the RL model 226 is explained in detail with reference to FIGS. 6A and 6B.

Once the RL agent 222 is trained based on the plurality of cardholder segments, the RL agent 222 adapts itself to optimize the spend policy threshold value for each spend policy rule to be able to have minimum fraud and decline rate. Further, the RL agent 222 is configured to continuously learn the spending behavior shift and adapt to the changing environment in real-time.

During an execution phase, when a payment authorization request is received by the server system 200, the RL agent 222 is configured to determine the optimal spend threshold values for the spend policy rules applicable for the payment transaction associated with the payment authorization request. In particular, the RL agent 222 is configured to determine a state in the RL model based on the current fraud rate and decline rate for at least one cardholder segment associated with the cardholder 104. The RL agent 222 is configured to set possible spend threshold values for the spend policy rules as actions in the reinforcement learning model.

Thereafter, the RL agent 222 is configured to determine Q-values corresponding to state-action pairs formed by the state and the actions using a neural network of the reinforcement learning model. The RL agent 222 is configured to select an action (i.e., particular spend threshold values for the spend policy rules) based at least on the determined Q-values and epsilon greedy policy methods. The RL agent 222 is configured to calculate a reward value corresponding to the selected action based, at least in part, on the reward function.

The processor 206 is configured to add the information of the spend threshold values for the spend policy rules corresponding to the reward value satisfying a predefined condition into the spend policy recommendation. Thus, the RL agent 222 needs to decide in real-time what spend threshold values for the spend policy rules to recommend to the issuer 102 for applying to a payment transaction.

The spend policy recommendation engine 224 includes suitable logic and/or interfaces for generating spend policy recommendation strategy for the payment transaction. The spend policy recommendation strategy may include information regarding the optimal spend policy threshold values determined by the RL agent 222 for the payment transaction. In one embodiment, the spend policy recommendation engine 224 is configured to transmit the spend policy recommendation strategy along with the payment authorization request to an issuer server 102 associated with the cardholder 104a.

In another embodiment, the spend policy recommendation engine 224 is configured to generate a supplemental authorization message indicating whether to approve the payment transaction or not. The supplemental authorization message may be sent to the issuer server 102 associated with the cardholder 104a along with the payment authorization request.

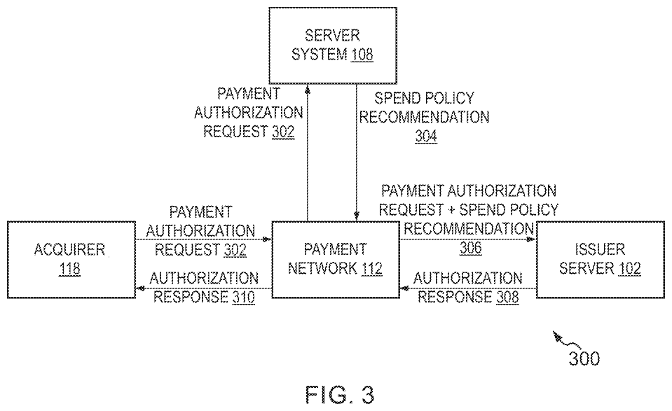

FIG. 3 represents an information flow 300 among various entities of the environment 100, in accordance with an embodiment of the present disclosure. Initially, the acquirer 118 transmits a payment authorization request 302 to the payment network 112. The payment authorization request 302 is associated with a payment transaction initiated by a cardholder 104. The payment network 112 may forward the payment authorization request 302 to the server system 108 that determines optimal spend threshold values for spend policy rules applicable to the payment transaction. The server system 108 may transmit a spend policy recommendation 304 including information of the optimal spend threshold values for the spend policy rule that need to be applied over the payment transaction for issuer authorization, to the payment network 112. The payment network 112 sends the payment authorization request along with the spend policy recommendation (See, 306) to the issuer server 102. The issuer server 102 utilizes the spend policy recommendation to decide whether to approve the payment transaction or not. Thereafter, the issuer server 102 transmits authorization response 308 to the payment network 112. The payment network 112 then sends the authorization response 310 to the acquirer 118 to complete the payment process.

In another embodiment, instead of transmitting the spend policy recommendation, the server system 108 may generate a supplemental authorization message indicating whether to approve the payment transaction or not. The supplemental authorization message is generated after comparing spend threshold values of spend policy rules with various transaction velocity features. In yet another embodiment, the server system 108 may directly be connected with the issuer server 102, rather than the payment network 112.

FIG. 4 is a block diagram representation of a reinforcement learning (RL) model 400, in accordance with an embodiment of the present disclosure. The RL model 400 involves two entities, i.e., an agent 402 (similar to the RL agent 222) and an environment 404 that interact with each other. The agent 402 is an entity that determines optimal spend threshold values corresponding to spend policy rules for each cardholder segment in dynamic manner, and the environment 404 may be set to feedback a reward value depending upon fraud rates and decline rates of a particular payment transaction after setting a specific spend threshold value for a spend policy rule. The reinforcement learning (RL) model 400 implements Markov Decision Process (MDP). The MDP may be represented by a four-tuple <S, A, R, T>, where,

1) S is a State Space, which includes a set of environmental states that the agent 402 may perceive. Herein, at any time t, a state of the RL model is defined as decline rate and fraud rate observed for a particular spend threshold for a spend policy rule.

2) A is an Action Space, which includes a set of actions that the agent 402 may take on each state of the environment 404. Herein, the action space refers to all possible values of spend thresholds set for the spend policy rule.

3) R is a reward function and R(s, a, s′) represents a reward that the agent 402 obtains from the environment 404 when the action ‘a’ is performed on the state s and the state is changed to state s′. Herein, the reward function represents a function that gives negative reward when the fraud and decline rates increase and gives positive reward when fraud and decline rate decrease.

4) T is a state transition function and T(s, a, s′) may represent a probability of executing action ‘a’ on state ‘s’ and moving to state s′.

Further, the MDP methods may also require following parameters to define:

5) Episode: One episode represents sequences of states defined based on fraud rate and decline rate for each spend policy rule within a particular time interval (e.g., year);

6) Policy Network: A stochastic policy outputs the possibility of an action for every time step t.

In the process of interaction between the agent 402 and the environment 404 in the MDP, the agent 402 senses that the environment state at time t is ‘sₜ’. Based on the environment state ‘sₜ’, the agent 402 may select an action ‘aₜ’ from the action space A to execute. After the environment 404 receives the action selected by the agent 402, it returns corresponding reward signal feedback Rₜ₊₁ to the agent 402 and transfers to new environment state ‘sₜ₊₁’, and waits for the agent 402 to make a new decision. In the process of interacting with the environment 404, the goal of the agent 402 is to find an optimal strategy such that the optimal strategy obtains the largest long-term cumulative reward in any state ‘s’ and any time step t.

The total reward is also called as Q-value denoted using the following equation:

Q(s,a)=r(s,a)+γ max Q(s′,a) Eqn. (1)

The above equation states that the Q-value yielded from being at state ‘s’ and performing action ‘a’ is equal to the immediate reward r(s, a) plus the highest Q-value possible from the next state ‘s’ and Gamma (γ) is a discount factor which controls the contribution of rewards further in the future. In other words, the Q(s, a) is a cumulative reward value of rewards generated in the subsequent learning optimization when the agent 402 executes the action ‘a’ in the state ‘s’.

Further, in the reinforcement learning model 400, a neural network architecture is utilized to approximate Q value-function. The state is given as the input and the Q-values of all possible actions are generated as the output. Based on the above reinforcement learning model 400, the server system 200 provided by the present disclosure dynamically determines optimized spend threshold values for each spend policy rule for different cardholder segments. The server system 200 iteratively performs a plurality of episodes to minimize the fraud and decline rates based on spend threshold values, to finally learn the optimal spend threshold values for spend policy rules to be applicable for various types of payment transactions and cardholders.

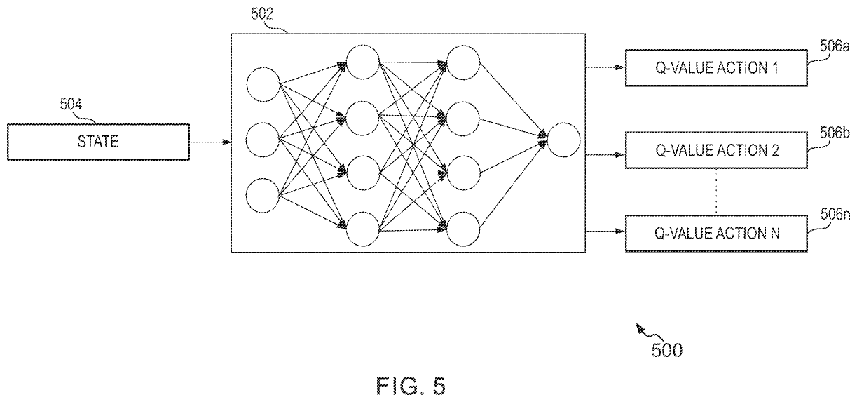

FIG. 5 is a block diagram representation of a neural network architecture of a reinforcement learning model 500, in accordance with an embodiment of the present disclosure.

As mentioned above, in reinforcement learning, in the process of interacting with the environment, the goal of the RL agent 402 is to find an optimal strategy such that the RL agent 402 receives the maximum cumulative reward in any state s and any time step t. In some example embodiments, the above objective may be achieved using a Q-value function approximation algorithm. In other example embodiments, the foregoing objectives may also be implemented by using other reinforcement learning algorithms such as a strategy approximation algorithm, which is not limited herein.

In one embodiment, the reinforcement learning model 500 may include one or more neural networks. In one embodiment, the neural network 502 includes an input layer, multiple hidden layers, and an output layer. The neural network 502 is utilized to approximate the Q-value function. The MDP in the reinforcement learning model includes a state space S and an action space A, wherein the fraud rate and decline rates based on the spend threshold values correspond to the state space S, and setting the spend threshold values for plurality of spend policy rules correspond to the action space A.

The action space of the environment is all possible spend threshold values set for each spend policy rule. Since the spend threshold value on the spend policy rule could be single transaction limit or transaction velocity limit on transaction happening on a geography and channel combination is continuous that results a large action space A. To tackle large action spaces, following methods may be used:

a) The action space can be learned by utilizing a generalized value function. The factorized policy no is parameterized by an embedding-to-action mapping function(f: ε→A), where ε denotes action representation space and an internal policy πᵢ is utilized to map state space to action representation.

b) The continuous action space is discretized into bins and the RL model 500 is configured to learn probability distribution over discretized action space via policy gradient methods.

More illustratively, during the training, the RL model 500 runs multiple episodes by initializing random spend threshold values, and identifies reward values corresponding to the multiple episodes using a reward function. In one embodiment, the RL model 500 is trained based on spend behavior of each cardholder segment.

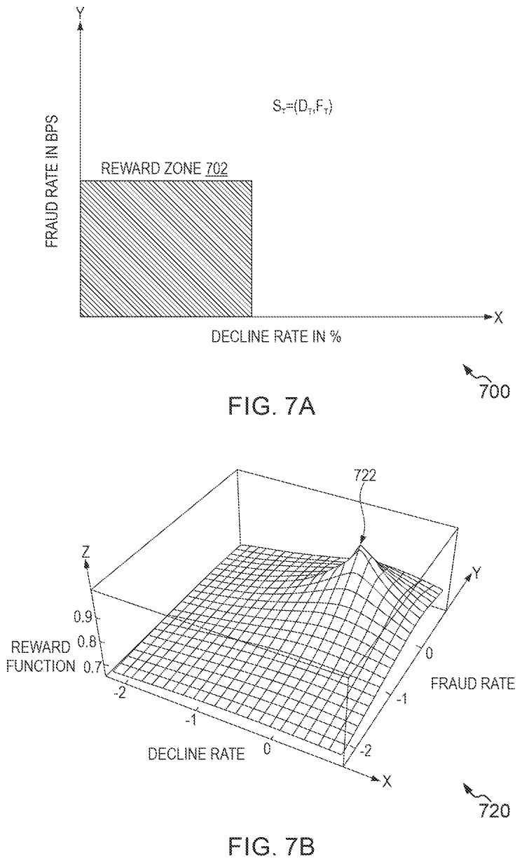

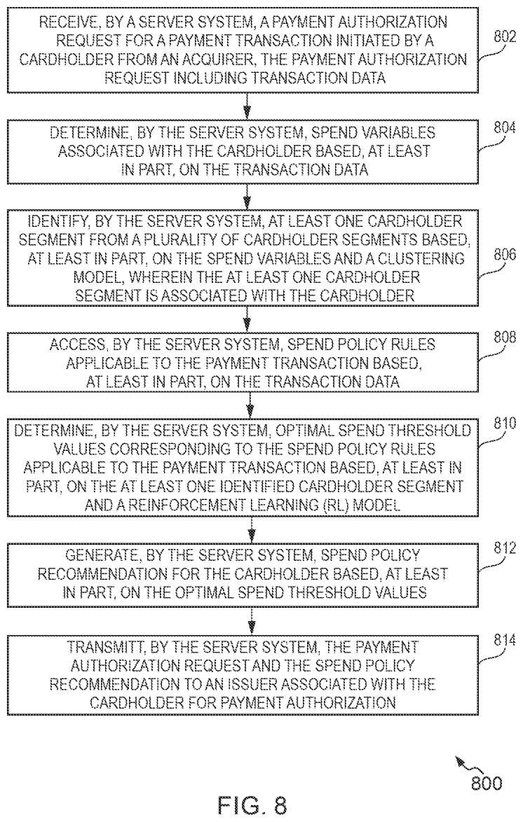

In one embodiment, the reward function is defined based on the effect of applying a particular spend threshold value for a spend policy rule for setting spend limits for a cardholder segment associated with the issuer 102. In other words, the reward function is defined based on overall fraud rate and decline rate after setting the particular spend threshold value for the spend policy rule. The reward function is defined as follows:

$${R}_{1} = f ( fraud rate , decline rate ) = \frac{0.5}{1 + log ( 1 + √ {f}^{2} + {d}^{2} )} + 0.5 * 1 \qquad Eqn . ( 2 )$$

where Rₜ is the reward function, f is fraud rate, d is decline rate, and I is an indicator variable that ensures to give high reward when the RL model enters into a reward zone. Further, the indicator variable incentivizes the RL model to move more towards the reward zone. Detailed explanation with reference to the reward zone is provided with respect to FIGS. 7A and 7B.

The input to the neural network 502 is a state 504. The state 504 represents decline rate and fraud rate observed for a particular spend threshold value corresponding to each spend rule. In one example, the decline and fraud rates are calculated by cumulating decline and fraud rates of payment transactions associated with at least one cardholder segment. The decline and fraud rates are obtained by utilizing the existing fraud and decline rate calculation models used by the issuer server 102.

In an example the current state may be defined as S₀=(f₀, d₀). The current state will get changed when the RL model changes spend threshold values for a spend rule. The spend threshold value for each spend policy rule is initialized randomly.

The output of the neural network 502 represents predicted Q-values (i.e., Q value-action 1 506a, Q value-action 2 506b . . . Q value-action n 506n) for each state-action pair. The action represents setting spend policy threshold values. The loss function is the mean squared error of the predicted Q-value and the target Q-value. To the extent the predicted Q value from the neural network 502 differs from the target Q-value, various training techniques, (such as, back propagation, stochastic gradient descent, policy gradient, etc.) may be employed to adjust various weights associated with the neural network 502 to reduce the loss function.

In one example, the loss function is formulated based on policy gradient methods utilized for training the RL model. The objective of the policy gradient methods is to find an optimal policy that minimizes overall fraud rate as well as decline rate. In one example, the policy gradient methods use Monte Carlo rollout to compute the total rewards by playing out the whole episode.

Based on the reward value, the RL model is configured to take an action that will further optimize the fraud and decline rates. Similarly, a sequence of state and actions are obtained for an episode. A plurality of such episodes may be performed by the RL model for training purposes. Thus, the processor 206 is configured to determine the current state and according to a certain strategy, outputs the corresponding action ‘a’. The processor 206 may determine optimal spend threshold values for all the applicable spend policy rules for payment transactions initiated by a cardholder.

For training the RL model, a random spend threshold value is assigned corresponding to each spend policy rule at the beginning of a month. In one example, the issuer 102 may define generalized spend threshold values for spend policy rules to be applied over payment transactions of cardholders. Based on the initialization, an initial state of the RL model 500 is defined based on fraud rate and decline rate after applying the random spend threshold value for each spend policy rule. Thus, an RL policy no is initialized randomly at beginning of the month.

Thereafter, the processor 206 is configured to calculate new fraud rate fₜ, and new decline rate dₜ at the end of the month which becomes the new state for the RL model. The reward value is calculated based on the Eqn. (2). Based on the reward value, the RL model takes an action (i.e., set a different spend threshold values for each spend policy rule) that results the new RL policy π₁.

With (π₁) as the new RL policy, at the end of the second month, new fraud rate and new decline rate are calculated that defines the new state for the RL agent and the reward is the calculated for this new state based on which action/new spend thresholds are set for third month and so on and so forth till the end of 12^{th} month. This sequence of <S1,A1,R1|S2,A2,R2| . . . |S12,A12,R12> is 1 episode for training.

The processor 206 is configured to simulate various episodes which mimic a spend policy for optimizing overall fraud and decline rates.

FIGS. 6A and 6B, collectively, represent a flow chart 600 for training the reinforcement learning model 500, in accordance with an embodiment of the present disclosure. The sequence of operations of the flow chart 600 may not be necessarily executed in the same order as they are presented. Further, one or more operations may be grouped and performed in the form of a single step, or one operation may have several sub-steps that may be performed in parallel or in a sequential manner.

At 602, the server system 200 accesses historical transaction data associated with a plurality of cardholders for a particular time interval (e.g., 12 months). The historical payment transaction data includes, but is not limited to, payment authorization data of past spend transactions made by the cardholder 104 within a particular time duration (for example, last one year). The payment authorization data of a spend transaction may include, but not limited to, authorization response (e.g., approve or decline), issuer identifier, acquirer identifier, merchant category code (MCC), merchant identifier, cross-border transaction flag, payment card type (e.g., debit card, credit card, prepaid card, etc.), spend transaction amount, transaction date and time, etc. The server system 200 is configured to aggregate spend transaction amounts of the past spend transactions on a timely basis based on various payment transaction features such as, geography, card product types, transaction channel and merchant category code (MCC).

At 604, the server system 200 derives spend variables for the plurality of cardholders based on the historical transaction data. The spend variables may include transaction velocity features based on the various payment transaction features such as, geography, and transaction channel, customer risk profiles (e.g., fraud patterns) of a cardholder based on spends at the different merchants, proportions of spend transactions with high fraud score transactions.

At 606, the server system 200 generates a plurality of cardholder segments based on the spend variables. In other words, the server system 200 segments the plurality of cardholders into homogenous cardholder segments based on spend behavior.

At 608, the server system 200 trains the reinforcement learning (RL) model based, at least, on the plurality of cardholder segments and cardholder level spend behavior features. The training of the reinforcement learning model is performed at steps 610-620.

At 610, the server system 200 defines a state space of the RL model. The state space may include a plurality of states. Each state corresponds decline rate and fraud rate at a particular time stamp. The state may get changed after changing spend threshold values for spend policy rules.

At 612, the server system 200 defines an action space of the RL model. The action space refers to all possible values of spend thresholds that can be set for each spend policy rule. In one embodiment, the action space is discretized into bins (i.e., a range of spend policy threshold values for a spend policy rule) and then the action space may represent a probability distribution across the bins.

After defining the state and action spaces, at 614, the server system 200 simulates or runs a plurality of episodes for determining an optimal spend threshold value of each spend policy rule for a particular cardholder segment (e.g., Cardholder segment “CS1”). Thereafter, the steps or operations 614a-614d are performed in iterative manner.

Each episode associated with a particular time interval (for example, 12 months) represents a sequence of setting spend threshold values for a plurality of spend policy rules on specific time basis (e.g., monthly), resulting in different fraud and decline rates for payment transactions of a particular cardholder segment within the particular time interval (e.g., 12 months). Each simulated episode may contain a plurality of state-action pairs corresponding to the actions taken to set a spend policy threshold value of each spend policy rule. In an example embodiment, a policy gradient approach is utilized to determine an optimal policy. The policy gradient with Monte Carlo rollouts may be catered to compute the rewards. More particularly, the Monte Carlo rollouts are used to play out a whole episode and compute total rewards for the episode and determine if the episode is an optimal policy or not.

At 614a, the server system 200 selects a random spend threshold value for each spend policy rule. The spend threshold values may be a limiting value on a transaction amount or a count for the number of transactions that limits the cardholder from making transactions that are against the spend policy rule, hence, an alert is provided to the issuer 102. In one example, the server system 200 selects the random spend threshold value for each spend policy rule at a beginning of a month and an RL policy is initialized randomly.

At 614b, the server system 200 identifies a current state of the RL model at a particular time by determining current fraud and decline rates for payment transactions of a cardholder segment “CS1”. The current fraud and decline rates define the current state of the RL model.

At 614c, the server system 200 calculates an immediate reward value based on a reward function (see, Eqn. (2)). The immediate reward value may be defined based on new fraud rate and new decline rate at the end of the month. Based on the new fraud rate and new decline rate, the RL model goes to next state.

At 614d, the server system 200 takes an action by setting a different spend threshold value for each spend policy rule that defines the new RL policy π₁. With (π₁) as the new RL policy, at the end of the second month, new fraud rate and approval rate are calculated which become the new state for the RL model and the immediate reward value is the calculated for this new state based on which action/new thresholds are set for third month and so on and so forth till the end of 12^{th} month. This sequence of <S1,A1,R1|S2,A2,R2| . . . |S12,A12,R12> is 1 episode for training. The steps 614a-614d are performed one or more times to complete an episode of training. For example, 12 such iterations may be performed to complete an episode.

Thus, the server system 200 calculates immediate reward values corresponding to state-action pairs in the episode based on the reward function (according to Eqn. (2)). The state-action pair represents fraud and decline rates after applying a particular spend threshold value for each spend policy rule. Further, based on the immediate reward values, the state-action pairs maybe determined to be optimal or sub-optimal. An optimal state-action pair corresponds to optimal spend threshold values that may reduce fraud and decline rates. The immediate reward value may be based on multiple different values and may be determined using an algorithm that weigh different values differently.

At 616, the server system 200 calculates a cumulative reward value corresponding to the simulated episode.

At 618, based on the cumulative reward value corresponding to the episode, the server system 200 determines whether the sequence of spend threshold values of each spend policy rule for the cardholder segment “CS1” is optimal or sub-optimal. In other words, the server system 200 determines whether the episode is optimal or sub-optimal.

At 620, the server system 200 updates the neural network parameters based on sampled triplets (i.e., state, action, reward combination pairs) of the sub-optimal episodes. In particular, the server system 200 adjusts neural network parameters of the RL model using the sampled combination pairs through a back-propagation process. The server system 200 calculates a loss function for each episode that is enabled with actor-critic to reduce the variance.

The running of a new episode is stopped when a convergence point is met. The convergence point refers to a cumulative reward value for the state-action pairs for an episode has been maximized to a predefined threshold value. In one embodiment, the convergence point refers to the reinforce loss function of the episode being lower than a preset value.

In one embodiment, the server system 200 determines the Q-value function and store the Q-values in the memory. The Q-value function is approximated to an optimal Q-value using the neural network using which the RL model is implemented. In one embodiment, the Q-value function about state ‘s’ and action ‘a’ is constructed based on a regression model which may include linear regression, tree regression, neural network, and other means.

Initially, the neural network parameters of the neural network in the DRL model may be initialized stochastically, or randomly. Based on the cumulative reward value, the neural network parameters can use the difference between its expected reward and the ground-truth reward to adjust its weights and improve its interpretation of state-action pairs. The formula of the Q-value function may include:

Q(Sₜ,Aₜ)←Q(Sₜ,Aₜ)+α[Rₜ₊₁+γ maxₐQ(Sₜ₊₁,a)−Q(Sₜ,Aₜ)] Eqn. (3)

Where Q(St, At) represents the estimated cumulative reward value obtained by executing the action At in the state St; Rₜ+1 represents the immediate reward value obtained in the next state St+1 after executing the action At in the state St; max Q(St+1, a) represents the estimated optimal value that is obtained under state St+1; and α∈(0,1] represents the influence of estimation error, similar to stochastic gradient descent and finally converges to the optimal Q-value.

According to the definition of Eqn. (3), the Q-Learning valuation iteration is performed using historical decline and fraud rates for different spend threshold values of each spend policy rule. In particular, the Q-value for the setting dynamic spend threshold value for each spend policy rule may be updated.

For example, the state definitions corresponding to decline and fraud rates are denoted as S1-S10. The updated Q-values corresponding to each state are Q1-Q10. In one example, the state S1 represents the fraud rate and decline rates of payment transactions associated with the particular cardholder segment after applying spend policy rules. Then, immediate reward values obtained in the state S1 after applying actions 1 to 10 are calculated and a maximum reward value associated with an action is updated as an optimal Q value for the state S1.

It should be noted that the value function used in the present disclosure is not limited to the state value function approximation algorithm (such as the Q-value function approximation algorithm described above), but may also include any reinforcement learning method that calculates the optimal action strategy in any state, such as a strategy approximation algorithm, which is not limited herein.

FIGS. 7A and 7B are graphical representations of a reward zone, in accordance with an embodiment of the present disclosure. The reward zone may be defined in connection with an authorization strategy of the issuer 102. The reward zone is defined in such a way that the RL model 226 is given extra reward when the environment in the RL model enters into the reward zone. The reward zone is defined based on two attributes namely, a threshold fraud rate and a threshold decline rate.

Since the reward function penalizes the RL model when fraud rate and decline rate increase and the reward function (see, Eqn. (2)) gives positive reward when fraud and decline rate decrease. Ideal outcome would be a fraud rate and decline rate of (0, 0), which is not possible. To compensate to that, a reward zone is defined by the issuer 102. The reward zone in acceptable fraud rate with a decline rate aligns with issuer's authorization strategy. The reward function is defined such that the RL model gets extra reward when it enters the reward zone but at the same time still thriving to move to (0, 0).

FIG. 7A is a two dimensional graph 700 representing the reward zone 702 defined based on a reward function for a particular issuer associated with a cardholder. The decline rate is marked along the X-axis of the graph 700 and the fraud rate is defined along the Y-axis of the graph 700. The reward zone 702 is defined to be present sharing the origin as it is the most optimized condition. The reward zone 702 is exemplarily shown to be shaded in FIG. 7A. The RL model may be rewarded with extra reward when the spend threshold values set by the RL model results in decline rate and fraud rate that lies inside the reward zone 702. In other words, the RL model may be rewarded with an additional reward when a current state of the RL model lies in the reward zone.

FIG. 7B is a three dimensional graph 720 representing the reward function plotted along the X-axis, decline rate along the Y-axis and the fraud rate along the Z-axis. The curve 722 is shown to monotonically spike when the decline and fraud rate are near to zero (0). The reward function is defined in such a way so as to increase the reward value when the fraud and decline rates decrease. The RL model may be rewarded with extra reward when the spend threshold values set by the RL model results in a decline rate and fraud rate that lies inside the reward zone.

FIG. 8 is a flow diagram of a computer-implemented method 800 for dynamically optimizing spend threshold values associated with spend policy rules using reinforcement learning model, in accordance with an example embodiment of the present disclosure. The method 800 depicted in the flow diagram may be executed by the payment server 114, or the server system 108, or the issuer server 102 as explained with reference to FIG. 1. Operations of the method 800, and combinations of operation in the method 800, may be implemented by, for example, hardware, firmware, a processor, circuitry and/or a different device associated with the execution of software that includes one or more computer program instructions. It is noted that the operations of the method 800 can be described and/or practiced by using a system other than the server systems. The method 800 starts at operation 802.

At the operation 802, the method 800 includes receiving a payment authorization request for a payment transaction initiated by a cardholder 104 from an acquirer 118. The payment authorization request includes transaction data.

At operation 804, the method 800 includes determining spend variables associated with the cardholder based, at least in part, on the transaction data.

At operation 806, the method 800 includes identifying at least one cardholder segment from a plurality of cardholder segments based, at least in part, on the spend variables and a clustering model. The at least one cardholder segment is associated with the cardholder 104. In other words, spend behavior associated with the at least one cardholder segment have similar characteristics as the cardholder 104.

At operation 808, the method 800 includes accessing spend policy rules applicable to the payment transaction based, at least in part, on the transaction data from the database 110.

At 810, the method 800 includes determining optimal spend threshold values corresponding to the spend policy rules applicable to the payment transaction based, at least in part, on the at least one identified cardholder segment and a reinforcement learning (RL) model.

At 812, the method 800 includes generating spend policy recommendation for the cardholder based, at least in part, on the optimal spend threshold values.

At 814, the method 800 includes transmitting the spend policy recommendation and the payment authorization request to an issuer 102 associated with the cardholder 104 for payment authorization.

The sequence of operations of the method 800 need not to be necessarily executed in the same order as they are presented. Further, one or more operations may be grouped together and performed in form of a single step, or one operation may have several sub-steps that may be performed in parallel or in sequential manner.

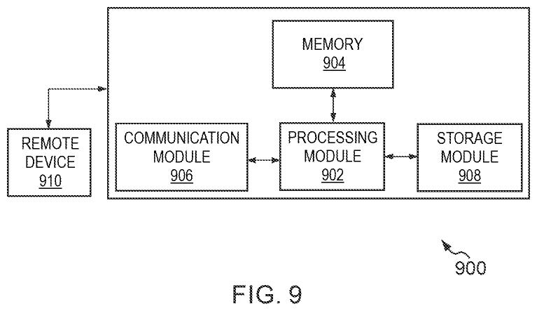

FIG. 9 is a simplified block diagram of an issuer server 900 of the one or more of the cardholders 104, in accordance with an embodiment of the present disclosure. The issuer server 900 is an example of the issuer server 102 of FIG. 1, or may be embodied in one of the issuer servers 108. The issuer server 900 is associated with an issuer bank/issuer, in which a cardholder (e.g., the cardholder 104a) may have a payment account, which provides a payment card such as the payment card 106a. The issuer server 900 includes a processing module 902 and a memory 904 operatively coupled to a storage module 910 and a communication module 906. The components of the issuer server 900 provided herein may not be exhaustive and that the issuer server 900 may include more or fewer components than that of depicted in FIG. 9. Further, two or more components may be embodied in one single component, and/or one component may be configured using multiple sub-components to achieve the desired functionalities. Some components of the issuer server 900 may be configured using hardware elements, software elements, firmware elements and/or combination thereof.

The storage module 908 is configured to store machine executable instructions to be accessed by the processing module 902. Additionally, the storage module 908 stores information related to, contact information of the user, bank account number, availability of funds in the account, payment card details, transaction details and/or the like.

The processing module 902 is configured to communicate with one or more remote devices such as a remote device 910 using the communication module 906 over a network, such as the network 116 of FIG. 1. The examples of the remote device 912 include the payment server 114, the acquirer server 118, or other computing systems of issuer and the network 116 and the like. The communication module 906 is capable of facilitating such operative communication with the remote devices and cloud servers using API (Application Program Interface) calls. The processing module 902 receives a payment authorization request including a payment transaction amount, cardholder information and merchant information from remote device 910 (i.e. the payment server 114).

In an additional embodiment, the RL model may be incorporated in the processing module 902 of the issuer server 900. The issuer server 900 may determine the dynamic optimal spend policy threshold using the RL model at the issuer server side itself and apply the same during the payment authorization of the corresponding payment transaction.

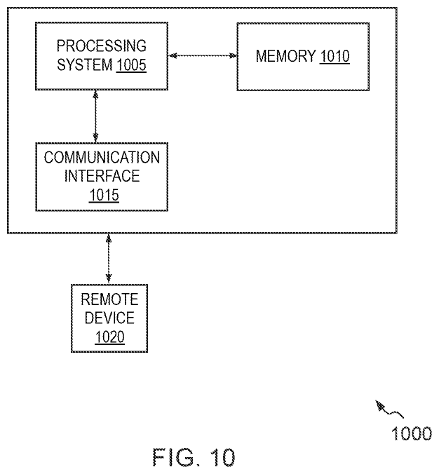

FIG. 10 is a simplified block diagram of a payment server 1000, in accordance with an embodiment of the present disclosure. The payment server 1000 is an example of the payment server 114 of FIG. 1. A payment network may be used by the payment server 1000 as a payment interchange network. Examples of payment interchange network include, but not limited to, Mastercard® payment system interchange network. The payment server 1000 includes a processing system 1005 configured to extract programming instructions from a memory 1010 to provide various features of the present disclosure. Further, two or more components may be embodied in one single component, and/or one component may be configured using multiple sub-components to achieve the desired functionalities. Some components of the payment server 1000 may be configured using hardware elements, software elements, firmware elements and/or a combination thereof. In one embodiment, the payment server 1000 is configured to determine an optimal spend threshold value for a spend policy rule applicable to a cardholder who has initiated the payment transaction. The spend policy threshold value may then be sent in the form of a supplementation authorization message to an issuer server such as the issuer server 900 associated with the cardholder.

Via a communication interface 1015, the processing system 1005 receives a payment authorization request from a remote device 1020 such as the server system 108, the acquirer server 118, or administrators managing server activities. The payment server 1000 may also perform similar operations as performed by the server system 200. For the sake of brevity, the detailed explanation of the payment server 1000 is omitted herein with reference to the FIG. 2.

The disclosed method 800 with reference to FIG. 8, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed:

1. A computer-implemented method comprising:
receiving, by a server system, a payment authorization request for a payment transaction initiated by a cardholder from an acquirer, the payment authorization request comprising transaction data;
determining, by the server system, spend variables associated with the cardholder based, at least in part, on the transaction data;
identifying, by the server system, at least one cardholder segment from a plurality of cardholder segments based, at least in part, on the spend variables and a clustering model, wherein the at least one cardholder segment is associated with the cardholder;
accessing, by the server system, spend policy rules applicable to the payment transaction based, at least in part, on the transaction data;
determining, by the server system, optimal spend threshold values corresponding to the spend policy rules applicable to the payment transaction based, at least in part, on the at least one identified cardholder segment and a reinforcement learning (RL) model; and
generating, by the server system, spend policy recommendation for the cardholder based, at least in part, on the optimal spend threshold values.

2. The computer-implemented method as claimed in claim 1, further comprising:
transmitting, by the server system, the spend policy recommendation and the payment authorization request to an issuer associated with the cardholder for payment authorization.

3. The computer-implemented method as claimed in claim 1, wherein the clustering model is a deep embedded clustering model.

4. The computer-implemented method as claimed in claim 3, wherein the plurality of cardholder segments is generated by applying the deep embedded clustering model on spend variables of a plurality of cardholders.

5. The computer-implemented method as claimed in claim 1, wherein the RL model is trained based, at least in part, on historical transaction data associated with each cardholder segment within a particular time interval.

6. The computer-implemented method as claimed in claim 5, wherein the RL model is trained by:
defining a state space of the RL model including a plurality of states, each state of the plurality of states representing decline rate and fraud rate at a time;
defining an action space of the RL model, the action space comprising a plurality of actions as setting spend threshold values for a plurality of spend policy rules;
simulating an episode from a plurality of episodes of setting spend threshold values of each spend policy rule for a particular cardholder segment, each episode representing a sequence of setting spend threshold values for the plurality of spend policy rules;
calculating immediate reward values of state-action pairs associated with the episode based, at least in part, on a reward function, each state-action pair representing fraud and decline rates after applying a particular spend threshold value for each spend policy rule;
calculating a cumulative reward value associated with the episode of the plurality of episodes;
determining whether the simulated episode is optimal or sub-optimal; and
in response to determining that the simulated episode is sub-optimal, updating neural network parameters of the RL model based, at least in part, on state, action and reward combination pairs of the simulated episode.

7. The computer-implemented method as claimed in claim 6, wherein simulating the episode comprises performing one or more operations in iterative manner, the one or more operations comprising:
selecting a random spend threshold value for each spend policy rule;
identifying a current state of the RL model based, at least in part, on current decline and fraud rates for payment transactions of the particular cardholder segment;
calculating an immediate reward value based, at least in part, on the reward function; and
performing an action by setting a different spend threshold value for each spend policy rule.

8. The computer-implemented method as claimed in claim 6, wherein the reward function is a function of overall fraud rate and decline rate for each spend policy rule.

9. The computer-implemented method as claimed in claim 8, wherein the RL model is rewarded with an additional reward when a state of the RL model lies in a reward zone, and wherein the reward zone is defined based on an authorization strategy of an issuer of the cardholder.

10. The computer-implemented method as claimed in claim 1, wherein the spend variables comprise one or more of:
transaction velocity features based on payment transaction features including geography and transaction channel,
customer risk profile of the cardholder based on spends at different merchants, and proportions of spend transactions with high fraud score transactions.

11. A server system comprising:
a processor; and
a computer storage medium storing instructions that are operative upon execution by the processor to:
receive, by a server system, a payment authorization request for a payment transaction initiated by a cardholder from an acquirer, the payment authorization request comprising transaction data;
determine, by the server system, spend variables associated with the cardholder based, at least in part, on the transaction data;
identify, by the server system, at least one cardholder segment from a plurality of cardholder segments based, at least in part, on the spend variables and a clustering model, wherein the at least one cardholder segment is associated with the cardholder;
access, by the server system, spend policy rules applicable to the payment transaction based, at least in part, on the transaction data;
determine, by the server system, optimal spend threshold values corresponding to the spend policy rules applicable to the payment transaction based, at least in part, on the at least one identified cardholder segment and a reinforcement learning (RL) model; and
generate, by the server system, spend policy recommendation for the cardholder based, at least in part, on the optimal spend threshold values.

12. The server system as claimed in claim 11, wherein the instructions are further operative to:
transmit, by the server system, the spend policy recommendation and the payment authorization request to an issuer associated with the cardholder for payment authorization.

13. The server system as claimed in claim 11, wherein the clustering model is a deep embedded clustering model.

14. The server system as claimed in claim 13, wherein the plurality of cardholder segments is generated by applying the deep embedded clustering model on spend variables of a plurality of cardholders.

15. The server system as claimed in claim 11, wherein the RL model is trained based, at least in part, on historical transaction data associated with each cardholder segment within a particular time interval.

16. The server system as claimed in claim 15, wherein the RL model is trained by:
defining a state space of the RL model including a plurality of states, each state of the plurality of states representing decline rate and fraud rate at a time;
defining an action space of the RL model, the action space comprising a plurality of actions as setting spend threshold values for a plurality of spend policy rules;
simulating an episode from a plurality of episodes of setting spend threshold values of each spend policy rule for a particular cardholder segment, each episode representing a sequence of setting spend threshold values for the plurality of spend policy rules;
calculating immediate reward values of state-action pairs associated with the episode based, at least in part, on a reward function, each state-action pair representing fraud and decline rates after applying a particular spend threshold value for each spend policy rule;
calculating a cumulative reward value associated with the episode of the plurality of episodes;
determining whether the simulated episode is optimal or sub-optimal; and
in response to determining that the simulated episode is sub-optimal, updating neural network parameters of the RL model based, at least in part, on state, action and reward combination pairs of the simulated episode.

17. The server system as claimed in claim 16, wherein simulating the episode comprises performing one or more operations in iterative manner, the one or more operations comprising:
selecting a random spend threshold value for each spend policy rule;
identifying a current state of the RL model based, at least in part, on current decline and fraud rates for payment transactions of the particular cardholder segment;
calculating an immediate reward value based, at least in part, on the reward function; and
performing an action by setting a different spend threshold value for each spend policy rule.

18. The server system as claimed in claim 16, wherein the reward function is a function of overall fraud rate and decline rate for each spend policy rule.

19. The server system as claimed in claim 18, wherein the RL model is rewarded with an additional reward when a state of the RL model lies in a reward zone, and wherein the reward zone is defined based on an authorization strategy of an issuer of the cardholder.

20. The server system as claimed in claim 11, wherein the spend variables comprise one or more of:
transaction velocity features based on payment transaction features including geography and transaction channel,
customer risk profile of the cardholder based on spends at different merchants, and
proportions of spend transactions with high fraud score transactions.
